(19) United States
(12) Patent Application Publication
(10) Pub. No.: US 2023/0363413 A1
(43) Pub. Date: Nov. 16, 2023

(54) Method for Palatable Delivery of Vitamins and Minerals in Dry Pet Feed

(71) Applicant: Ben Chernow, Alexandria, VA (US)

(72) Inventor: Ben Chernow, Alexandria, VA (US)

(21) Appl. No.: 18/216,356

(22) Filed: Jun. 29, 2023

Related U.S. Application Data
(63) Continuation of application No. 17/551,419, filed on Dec. 15, 2021.

(51) Int. Cl. A23K 10/20; A23K 10/30; A23K 20/22; A23K 20/20; A23K 20/26; A23K 20/24; A23K 20/174

(52) U.S. Cl. CPC A23K 10/20; A23K 10/30; A23K 20/22; A23K 20/30; A23K 20/26; A23K 20/24; A23K 20/174

(57) ABSTRACT

The invention is a method for the palatable delivery of nutrients in dry pet feed comprising the doping of feed components with such nutrients and a related pet feed.

### CROSS REFERENCE TO RELATED APPLICATIONS

This application claims priority to U.S. patent application Ser. No. 17/551,419, filed on Dec. 15, 2021.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a process for the palatable delivery of vitamins and/or minerals in freeze-dried pet feed.

### Background of the Invention

The pet feed market is bifurcated into “wet” feeds and “dry” feeds. Dry feeds constitute about 67% of the U.S. pet food market and over 50% of the global pet food market. Wet feeds are typically composed of chunks of pet feed within a gravy, sauce, or jelly, and are sold in cans or tins, with each package constituting an individual meal. Dry feeds are typically “kibble,” meaning pellets of varying size and shape, and are packaged in a bulk container comprising numerous meals. A key aspect of manufacturing dry feed is the removal of moisture, which is necessary to prevent spoliation. Moisture is generally removed by “cooking” the feed at a high temperature and evaporating water through heat.

An alternative method for removing moisture from dry pet feeds is freeze-drying, which involves (1) freezing, (2) lowering pressure, and (3) removing the ice through sublimation. Freeze-dried pet feeds are becoming increasingly popular because freeze-drying maintains nearly all of the nutritional value of fresh food, while much of this nutritional value is destroyed when cooked at high temperatures. The process for traditional cooking versus freeze-drying in preparing animal feed involves steps that are substantially similar or identical until the step of moisture removal.

A simplistic overview of the process for preparing dry pet feeds is as follows. First, the ingredients are aggregated in a large container. Common ingredients include meat, meal (a combination of animal derivatives unused by the human food industry such as organs and blood), cereals, grains, fruits and vegetables. These ingredients are typically milled or ground into a powder. The ingredients are then heated and “melted” together, and then mixed with water to create a dough, which is shaped into kibble and cooked. “Cooking” of kibble usually means baking the solution at a high temperature, often in an oven. For freeze-dried animal feed, however, “cooking” instead means putting the dough in a freeze-dryer. Once cooked or freeze-dried, the kibble can then be coated with additional flavors and/or preservatives.

Pet feed is regulated by individual state laws, which in turn are predicated upon the Association of American Feed Control Officials (AAFCO) model regulations. These regulations require minimum amounts of numerous nutrients, vitamins, and minerals in each serving of pet feed. These minimums effectively require the use of supplemental vitamins and minerals to satisfy the nutritional requirements.¹ Such vitamins and minerals are known as “premix” within the pet feed industry. Premix is typically incorporated into dry pet feed in one of two ways. ¹ There is one pet feed that does not use premix and is able to meet the requirements entirely through natural ingredients—Nature's Logic®. That company sells both freeze-dried and “kibble” versions of its feed.

In a first method for adding premix to dry feed, premix is mixed into the dough solution prior to cooking. This allows for uniform distribution of the premix, which in turn ensures that each individual serving satisfies the AAFCO nutritional requirements. The premix is within the dough when it is “cooked,” and thus the “cooked” kibble satisfies the nutritional requirements.

In a second method, the premix is included in the coating after the kibble is “cooked.” Often, this involves spraying the kibble with a “sticky” liquid (usually fat or a solution containing fat) and then “rolling” the sprayed kibble in a powdered premix. Alternatively, the premix can be in liquid form and sprayed directly onto the kibble.

The second method cannot work for freeze-dried feeds. Freeze-dried feeds are more sensitive to moisture than “baked” feeds, and spraying liquid reintroduces moisture, which causes freeze-dried food to spoil. As such, all freeze-dried pet feeds satisfy the nutritional requirements through the first method of adding premix to the dough.

Because premix is incorporated into the dough solution before “cooking,” all freeze-dried pets feeds are essentially “nuggets”—a block of food comprised of the numerous “melted” ingredients. Some pet feeds supplement these nuggets with freeze-dried morsels such as chicken, peas, cranberries, carrots, and/or blueberries. However, the necessity of premix renders the “nuggets” the core component of all freeze-dried pet feeds.

Companies have unsuccessfully tried to deviate from the process of incorporating premix into the dough prior to “cooking.” One notable example was the inclusion of vitamins as a separate ingredient within the feed. However, this failed because the vitamins were not palatable, and thus pets simply ate around the vitamins and consequently suffered nutritional deficiencies. This demonstrates the importance of palatability in any system used to deliver vitamins and/or minerals in pet feed.

What is needed is an improved method of incorporating nutrient-rich premix directly into pet feed during the cooking or preparation process.

### BRIEF SUMMARY OF THE INVENTION

In a preferred embodiment, a process for incorporating nutrients into pet feed, consisting of the following steps:
1. Creating a premix solution by adding a soluble premix containing nutritionally sufficient amounts of one or more vitamins or minerals into a premix into a chicken stock, broth or bullion solvent;
2. Heating the premix solution to facilitate absorption of the premix;
3. Creating doped rice by adding dry rice to the premix solution and cooking until edible;
4. Freeze-drying the doped rice; and
5. Combining the doped rice with freeze-dried base pet feed to create palatable dry pet feed that satisfies nutritional requirements.

In another preferred embodiment, the process for incorporating nutrients into pet feed as described herein, wherein the vitamins and minerals contained in the soluble premix are taken from the group consisting of: Calcium, Phosphorous, Potassium, Sodium, Chloride, Magnesium, Iron, Copper, Manganese, Zinc, Iodine, Selenium, Vitamin A, Vitamin D, Vitamin E, Thiamine, Riboflavin, Pantothenic Acid, Niacin, Pyridoxine, Folic Acid, Vitamin B12 and/or Choline.

In another preferred embodiment, the process for incorporating nutrients into pet feed as described herein, wherein the soluble premix contains nutritionally significant levels of all listed vitamins and minerals.

In another preferred embodiment, the process for incorporating nutrients into pet feed as described herein, wherein the premix solvent is a type of stock, broth or bullion made from one or more of beef, pork, chicken, mutton, duck, goose or any other appropriate animal.

In another preferred embodiment, a mixed pet feed containing doped rice including nutrients incorporated according to the process described herein.

In another preferred embodiment, a method for providing nutrients to animals, consisting of the steps: (1) incorporating nutrients into pet feed to create mixed pet feed according to the process described herein, and (2) feeding the mixed pet feed to an animal.

### BRIEF DESCRIPTION OF THE DRAWINGS

FIG. 1 is a flow chart evidencing a first embodiment of a process for incorporating nutrient premix into pet feed.

### DETAILED DESCRIPTION OF THE INVENTION

The invention constitutes a process for effectively incorporating premix into a pet feed in a palatable manner. This is done by “doping” rice with vitamins and/or minerals, which typically are cooked in chicken broth to make the doped rice palatable. The doped rice is then freeze-dried to preserve the rice and prevent spoliation. For the purposes herein, the term “dope” or “doping” shall be defined as the application of a mixture containing one or more nutrients (e.g., vitamins and minerals) to food pellets and/or ingredients comprising pet feed as a mechanism allowing animals to ingest such nutrients.

This method makes it possible to meet AAFCO and state regulations without following the traditional method of “melting” the ingredients together, which in turn renders the pet food “nugget” non-essential. As such, the feed can be comprised of distinct ingredients, similar to a trail mix, where each individual ingredient is separate and recognizable.

In a preferred embodiment, the inventive process constitutes the following steps:
Step 1: Dissolve and/or mix premix into a chicken stock solvent. The premix must be soluble and should provide amounts of vitamins and minerals, in amounts according to AAFCO regulations, as shown on the following list. Nutrient concentrations are expressed on a dry matter basis at a specified caloric density—the caloric density is 1000 kcal metabolizable energy (ME). Certain nutrients have maximums when they present a potential for overuse or toxicity.

| | Units per | | |
|---|---|---|---|
| | 1000 kcal | | |
| Nutrient | ME | Minimum | Maximum |
| Crude Protein | g | 45 | |
| Arginine | g | 1.28 | |
| Histidine | g | 0.48 | |
| Isoleucine | g | 0.95 | |
| Leucine | g | 1.7 | |
| Lysine | g | 1.58 | |
| Methionine | g | 0.83 | |
| Methionine-sytine | g | 1.63 | |
| Phenylalanine | g | 1.13 | |
| Phenylalanine-tyrosine | g | 1.85 | |
| Threonine | g | 1.2 | |
| Trytophan | g | 0.4 | |
| Valine | g | 1.23 | |
| Crude Fat | g | 13.8 | |
| Linoleic Acid (18:2) | g | 2.8 | |
| (Linoleic + | | | 30:1 |
| Arachidonic):(alpha- Linolenic + | | | |
| Eicosapentaenoic + | | | |
| Docosahexaenoic) acid ratio | | | |
| Minerals | | | |
| Calcium | g | 1.25 | 6.25 |
| Phosphorous | g | 1 | 4 |
| Ca:P Ratio | | 1:1 | 2:1 |
| Potassium | g | 1.5 | |
| Sodium | g | 0.2 | |
| Chloride | g | 0.3 | |
| Magnesium | g | 0.15 | |
| Iron | mg | 10 | |
| Copper | mg | 1.83 | |
| Manganese | mg | 1.25 | |
| Zinc | mg | 20 | |
| Iodine | mg | 0.25 | 2.75 |
| Selenium | mg | 0.08 | 0.5 |
| Vitamins and Others | | | |
| Vitamin A | IU | 1250 | 62,500 |
| Vitamin D | IU | 125 | 750 |
| Vitamin E | IU | 12.5 | |
| Thiamine | mg | 0.56 | |
| Riboflavin | mg | 1.3 | |
| Pantothenic acid | mg | 3 | |
| Niacin | mg | 3.4 | |
| Pyridoxine | mg | 0.38 | |
| Folic Acid | mg | 0.054 | |
| Vitamin B12 | mg | 0.007 | |
| Choline | mg | 340 | |

As used herein above, IU stands for international unit, a measurement/quantification of biological effectiveness of a fat-soluble/water-soluble vitamin (i.e., Vitamins A, E and D). The conversion for IU are as follows:

Vitamin A
One IU of Vitamin A=3/10 microgram

Vitamin E
One milligram of Vitamin E=approx 1.21 to 1.49 IU (depending on the carrier). 400 IU of d-alpha tocopherol=268 mg.

Vitamin D
One microgram of Vitamin D=40 IU.
400 IU of Vitamin D=10 ug.

Many premixes do not provide the full range of these vitamins and/or minerals. Accounting for any shortcomings in the vitamins and/or minerals provided by the premix is addressed below. In its preferred embodiment, this step results in a premix solution containing as many of listed vitamins and minerals as possible. Sufficiency of the amount of any included nutrient will reflect the AAFCO standards for the specific type of animal feed being treated.
Step 2: Heat the premix solution to facilitate absorption of premix and add rice. Cook the rice until edible.
Step 3: Freeze-dry cooked rice that has absorbed the premix (now constituting doped rice) to remove moisture from the rice and prevent spoliation.
Step 4: Mix doped rice with base pet feed. The base pet feed is also freeze-dried to prevent spoliation.

The base pet feed will contain ingredients to satisfy the nutritional requirements that are not provided through the “doped” rice. Such requirements include:
Crude Protein
Amino Acids such as Arginine and Tryptophan
Crude Fat
Fatty Acid and/or Linoleic Acid

The base pet feed nutrients are largely provided through protein sources such as meat and/or organ meats. As such, the feed composition will include substantial portions of freeze-dried protein sources such as meat and/or organ meats. Fruits and/or vegetables can also be used as needed to supplement vitamins and/or minerals that are not provided through the premix used in doping the rice.

The result is a freeze-dried pet feed comprised of distinct, separate ingredients, including the “doped” rice, meat and/or organ meat, fruits, and vegetables. Water may be added to the feed prior to feeding, but is not required.

The distinct aspect of this invention is the manner in which vitamins and/or minerals are incorporated into pet feed and/or delivered to pets. The doping of rice with vitamins is key because this allows for the delivery of vitamins and minerals by using the rice as a separate ingredient in pet feed, which in turn enables a transition from the “nugget”. Cooking in chicken stock is also important because it makes the doped rice palatable and thus ensures the delivery of the vitamins and minerals. Freeze-drying is also important because it preserves the rice and prevents spoliation.

This process successfully delivers the requisite vitamins and minerals in a palatable form that prevents animals from eating around the included nutrients. The rice doping process and product described herein has been subjected to laboratory testing and animal taste testing. The doped rice (1) sufficiently absorbs the nutritional premix, (2) satisfies AAFCO regulations, and (3) receives positive responses in taste tests with pets.

In alternate embodiments, types of stock or broth other than chicken stock may be employed as a solvent into which nutrients are dissolved. Such alternatives may include, without limitation, stock or broth based on beef or any other meat product, as well as chicken powder mixed with water. Any such solvent may accomplish the same purpose of making the doped rice palatable to animals. The stock may also be diluted to make the process more economical while achieving palatability.

In another alternate embodiment, the method may employ water or another liquid as a solvent. In such cases, the solvent might be augmented with a natural or artificial flavoring agent. Such animal flavorings include, inter alia, fat and oil solubles, as well as compounds such as 2-Isopropyl pyridine (bacon flavoring).

In a last alternate, grains or starches other than rice may be doped and included in pet feed. Many other grains can accomplish the same purpose of (1) absorbing the premix, and (2) absorbing the flavor of the stock, and thereby delivering the requisite vitamins and minerals in a palatable form. In particular, oats have been proven to sufficiently absorb premix and satisfy AAFCO regulations and perform well in taste tests. Without limitation, oats, barley, corn, wheat, quinoa, sorghum and potatoes are also possible replacements.

### DETAILED DESCRIPTION OF THE FIGURES

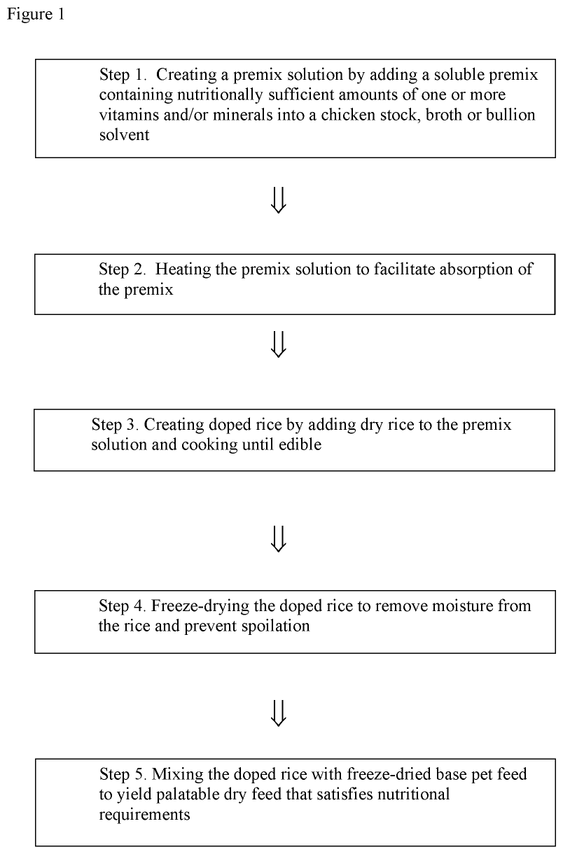

FIG. 1 is a flow chart evidencing the steps comprising a method of doping a grain for addition to pet feed as a mechanism for introducing nutrients into the feed.

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A process for incorporating nutrients into pet feed, consisting of the following steps:
1. Creating a premix solution by adding a soluble premix containing nutritionally sufficient amounts of one or more vitamins or minerals into a chicken stock, broth or bullion solvent;
2. Heating the premix solution to facilitate absorption of the premix;
3. Creating doped rice by adding dry rice to the premix solution and cooking until edible;
4. Freeze-drying the doped rice; and
5. Combining the doped rice with freeze-dried base pet feed to create palatable dry pet feed that satisfies nutritional requirements;
wherein the vitamins and minerals contained in the soluble premix are the following, expressed in units of weight per 1000 kcal ME:
1.2 g Calcium
1-4 g Phosphorous
1.5 g Potassium
0.2 g Sodium
0.3 g Chloride
0.15 g Magnesium
10 mg Iron
1.83 mg Copper
1.25 mg Manganese
20 mg Zinc
0.25-2.75 mg Iodine
0.08-0.5 mg Selenium
1250-62,500 IU Vitamin A
125-750 IU Vitamin D
12.5 IU Vitamin E
0.56 mg Thiamine
1.3 mg Riboflavin
3 mg Pantothenic Acid
3.4 mg Niacin
0.38 mg Pyridoxine
0.054 mg Folic Acid
0.007 mg Vitamin B12 and
340 mg Choline.

2. The process for incorporating nutrients into pet feed of claim 1, wherein the premix solvent is a type of stock, broth or bullion made from one or more of beef, pork, chicken, mutton, duck, goose or any other appropriate animal.

3. A mixed pet feed containing doped rice including nutrients incorporated according to the process of claim 1.

4. A method for providing nutrients to animals, consisting of the steps:
1. Incorporating nutrients into pet feed to create mixed pet feed according to the process of claim 1, and
2. Feeding the mixed pet feed to an animal.
